(19) United States
(12) Patent Application Publication
(10) Pub. No.: US 2013/0188156 A1
(43) Pub. Date: Jul. 25, 2013

(54) OPTICAL SYSTEM FOR PROJECTION DISPLAY APPARATUS

(71) Applicants: Dongha Kim, Yongin City (KR); Mankyum Kim, Gwangju City (KR); Byeongsoo Son, Suwon City (KR)

(72) Inventors: Dongha Kim, Yongin City (KR); Mankyum Kim, Gwangju City (KR); Byeongsoo Son, Suwon City (KR)

(73) Assignee: EPIC OPTIX, Annapolis, MD (US)

(21) Appl. No.: 13/806,291

(22) PCT Filed: Jun. 25, 2011
(86) PCT No.: PCT/IB11/01914

§ 371 Date: Apr. 8, 2013

(30) Foreign Application Priority Data
Jun. 25, 2010 (KR) 10-2010-0060755

(51) Int. Cl. G03B 21/00

(52) U.S. Cl. CPC G03B 21/008
USPC 353/81

(57) ABSTRACT

This invention concerns an optical system for a projection display device that includes: a first lens which may emit light entering from a light source with a same angle to a single point; a second lens which is positioned in a way that the light collected from the first lens may be transmitted to a digital micromirror device (DMD) with a predetermined angle; a DMD which may reflect the light entering from the second lens; a prism positioned between the second lens and the DMD that transmits and transfers the light emitted from the second lens to the DMD, and transfers the light reflected from the DMD to a projection lens by totally reflecting the light; and a projection lens that is positioned in the optical path of the light totally reflected from the prism, to project the light onto a screen. According to this invention, as described above, by providing an optical system for a projection display apparatus that is asymmetrically positioned by implementing a symmetric lens that compensates for the optical path difference of light incident on a DMD from a light source, the manufacturing of the system becomes easy. In particular, the use of the symmetric lens makes the lens processing and tolerance management easier at a lower price during the lens production compared to the conventional asymmetric lens. Also, it is easy to set the placement between the symmetric lens and the prism.

### TECHNOLOGICAL FIELD

This invention is about an optical system for a projection display apparatus.

### BACKGROUND TECHNOLOGY

FIG. 1 shows an optical system for a projection display apparatus based on the conventional technology. The optical system for a projection display apparatus based on the conventional technology includes: a light source (10); a digital micromirror device (DMD) (20) which receives the incident light (or the light beams) from the light source (10) and reflects it; a projection lens (30) positioned in the optical path of the reflected light from the DMD (20) to project the light onto a screen; a prism (40) positioned between the light source (10) and the DMD (20) to send the incident light from the light source (10) to the DMD (20) and to totally reflect the incident light from the DMD (20) to the projection lens (30); and an asymmetric lens (50) positioned between the light source (10) and the prism (40), especially, positioned parallel to an inclined plane of the prism (40).

As for the asymmetric lens (50), it is used to compensate for the light's characteristic of having various velocities in different media, that is, for the optical path difference of incident light (light beams) from the light source (10) to respective positions on the DMD (20).

However, such optical system for a projection display apparatus based on the conventional technology requires precision to compensate for the optical path difference, and thus involves the problem that it is very difficult to manufacture the asymmetric lens (50), and to set the placement between the asymmetric lens (50) and the prism (40).

### SUMMARY OF THE INVENTION

### Issues to Solve with the Invention

This invention may be used to solve the above-mentioned problems. It is intended to provide an optical system for a projection display apparatus that may compensate for the optical path difference without using an asymmetric lens that requires precise manufacturing.

### Means to Solve the Issues

To achieve the above-mentioned objective, the optical system of a projection display apparatus based on this invention includes: a first lens which may concentrate incident light from a light source having the same angle to a single point; a second lens which is positioned so that the light concentrated from the first lens may enter a digital micromirror device (DMD) with a predetermined angle; a DMD which may reflect the incident light from the second lens; a prism positioned between the second lens and the DMD that transmits and transfers the incident light from the second lens to the DMD, and transfers the reflected light from the DMD to a projection lens by totally reflecting the light; and a projection lens that is positioned in the optical path of the reflected light that is totally reflected from the prism to project the light onto a screen.

Herein, the second lens is a symmetric lens that has a positive refractive power, and may be asymmetrically positioned with respect to an optical axis. Especially, the second lens may be asymmetrically positioned in such a manner that the second lens may be rotated at an angle within the range of 0° to 90° between the central axis of the second lens and a normal of an inclined side of the prism, and the second lens may be asymmetrically positioned in such a manner that it may be eccentrically positioned in a direction that the central axis of the second lens is away from the exit surface of the prism.

### Effects of the Invention

According to this invention as described above, providing an optical system for a projection display apparatus that is asymmetrically positioned by implementing a symmetric lens that compensates for the optical path difference of incident light entering a DMD from a light source, the manufacturing of the system becomes easy. In particular, the use of a symmetric lens makes the lens processing and tolerance management easier at a lower price during the lens production phase compared to the conventional asymmetric lens. Also, it is easy to set the placement between the symmetric lens and the prism. Thus, the lens according to this invention may be applied to an optical system for a projection display apparatus that has various sizes and shapes.

### BRIEF DESCRIPTION OF THE DRAWINGS

FIG. 1 shows the optical system for a projection display apparatus based on the conventional technology;

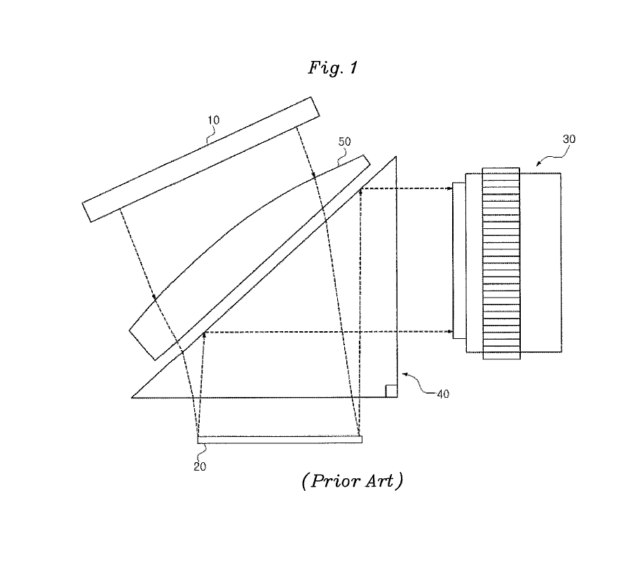

FIG. 2 shows the optical system for a projection display apparatus according to an implementation example of this invention;

FIG. 3 shows the asymmetric placement of the symmetric lens according to an implementation example of this invention;

FIG. 4 shows a process where the incident light beams from the light source enter the DMD from the first lens according to an implementation example of this invention;

FIG. 5 shows a process where the incident light beams to the first lens shown in FIG. 4 with the same angle are focused on the DMD; and

FIG. 6 shows a process where the light beams coming from one point are transmitted to the DMD by the second lens shown in FIG. 4.

### SPECIFIC DESCRIPTION TO IMPLEMENT THE INVENTION

A detailed description accompanied by the drawings is provided below. In the description of this invention, when any specific descriptions of known functions and constructions obvious to a person familiar with the art are determined to be unnecessarily obscuring the subject matter of this invention, the detailed description will be omitted.

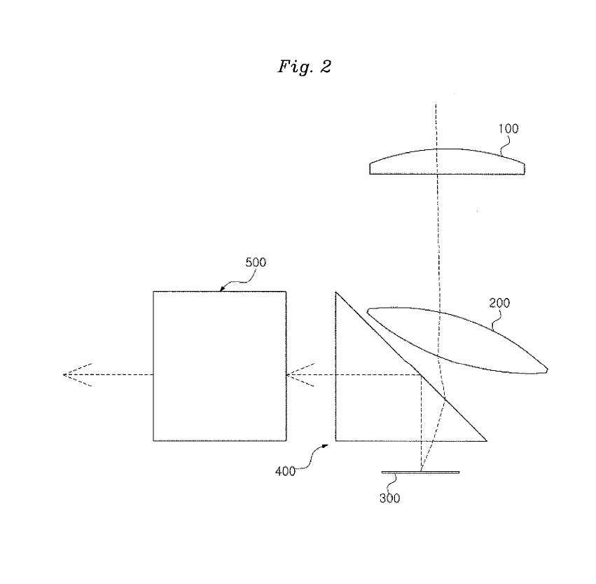

As shown in FIG. 2, an optical system for a projection display apparatus based on this invention includes: A first lens (100) that concentrates incident light from a light source with the same angle to a single point; a second lens (200) positioned in such a manner that the light concentrated by the first lens (100) may enter with a predetermined angle to a digital micromirror device (DMD) (300); a DMD (300) that reflects the incident light from the second lens (200); a prism (400) positioned between the second lens (200) and the DMD (300) so as to transmit the incident light from the second lens (200) to the DMD (300), and to transfer the reflected light from the DMD (300) to a projection lens (500) through total reflection; a projection lens (500) positioned in the optical path of the reflected light that is totally reflected from the prism (400) to project the light onto a screen.

As for the characteristics of the second lens (200), it is a symmetric lens that has a positive refractive power, and may be asymmetrically positioned with respect to the optical axis.

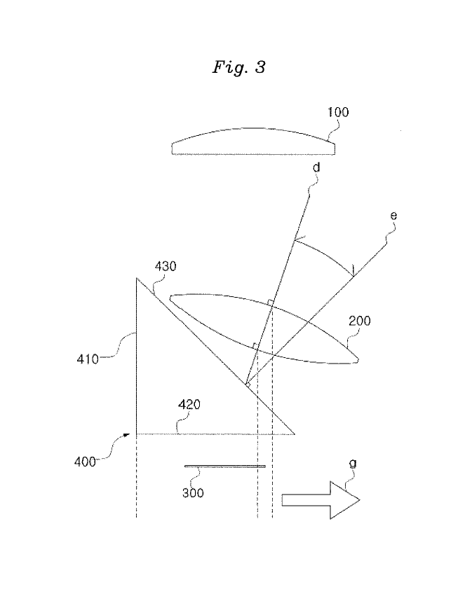

In particular, as shown in FIG. 3, the second lens (200) may be asymmetrically positioned in such a manner that it may be rotated at an angle (θ) within the range of 0° to 90° between a central axis (d) of the second lens (200) and a normal (e) of an inclined side of the prism (400), and it may be eccentrically positioned in a direction so that the central axis (d) of the second lens (200) is away from the exit surface (410) of a prism (410) (in a direction as indicated by arrow g).

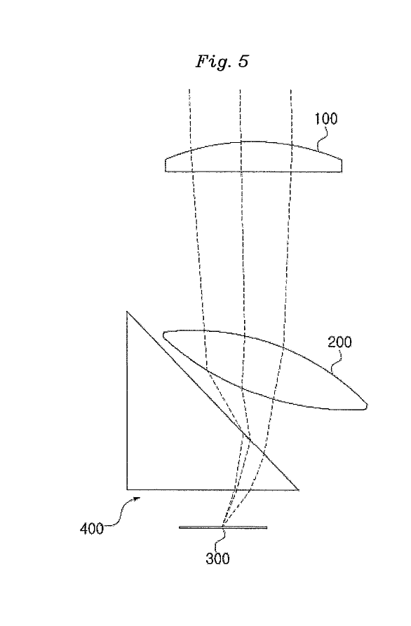

More specifically, the first lens (100) generally indicates a relay lens, and may be positioned, as shown in FIG. 5, in such a manner that incident light (light beams) with the same angle are focused on the same point on the DMD (300).

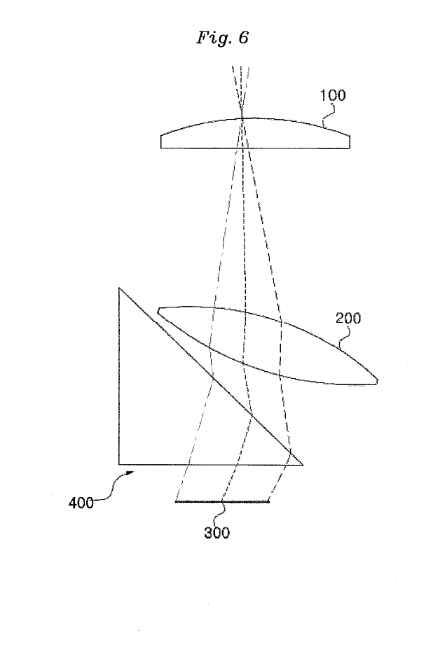

Also, the second lens (200) generally indicates a relay lens, and especially a symmetric lens that has a positive refractive power to concentrate the incident light through the lens. Meanwhile, the second lens (200), as shown in FIG. 6, uniformly disperses the light coming from the same point from the first lens (100) to respective areas of the DMD (300), and at this time, plays a role of making the angles of the light incident on the DMD (300) as much the same as possible.

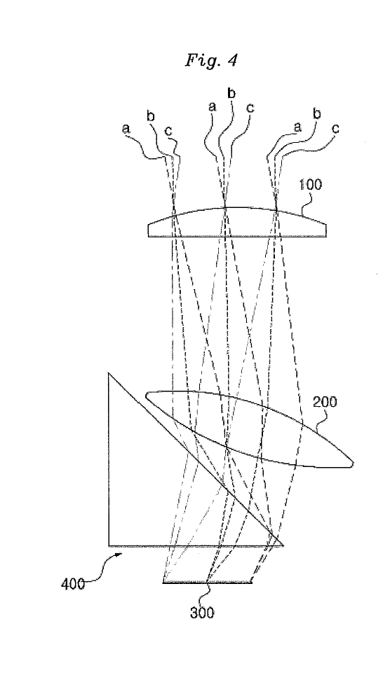

In other words, as shown in FIG. 4, when respective light beams (a, b, c) with different predetermined angles enter the respective points of the first lens (100), the first lens (100) allows light beams with the same angle to be focused on the same point on the DMD (300), and the second lens (200) allows the light beams (a, b, c) coming from the same point from the first lens (100) to be uniformly dispersed on the respective areas of the DMD (300).

The DMD (300) indicates a digital micromirror device, and, since it is a known technology, a detailed explanation will be omitted.

Also, as shown in FIG. 3, the cross-section of the prism (400) is a right triangle, and its inclined plane (or incidence surface) (430) may be positioned adjacently to the light source, and has a total internal reflection surface. Therefore, it is possible to totally reflect the reflected light from the DMD (300) to the projection lens (500). Also, one prism surface (420) facing the DMD (300) is positioned parallel to the DMD (300), and the other prism surface (410) facing the projection lens (500) is positioned perpendicularly to the optical axis of the projection lens (500). As described above, the prism (400) transmits the light entering the inclined plane (430) of the prism (400) from the second lens (200) to the DMD (300), and then totally reflects the reflected light (reflection light) from the DMD (300) from the inclined plane (430) (total reflection surface) inside the prism (400) to transmit the light to the projection lens.

In addition, the projection lens (500) projects the light totally reflected and transmitted from the prism (400) onto a screen (screen). In other words, it plays the role of projecting the image transmitted from the DMD (400) onto the screen.

According to this invention, as described above, providing an optical system for the projection display apparatus that compensates for the optical path difference of the light by placing a symmetric lens, the second lens (200), asymmetrically, the manufacturing of the system becomes easy. Particularly, as noted in Table 1 below, the use of the symmetric lens makes the lens processing and tolerance management easier at a lower price in the lens production phase compared to the conventional asymmetric lens. Also, it is easy to set the placement between the symmetric lens and the prism.

TABLE 1

| | conventional | symmetric lens (200) of |
|---|---|---|
| | asymmetric lens (50) | this invention |
| Processing | Difficult | Easy |
| Tolerance management | Difficult | Easy |
| Alignment | Difficult | Easy |
| Cost | High | Low |

As described above, although this invention has been illustrated using the drawings and the implementation example, the scope of this invention is not limited to the implementation example. Those skilled in the art will appreciate that various modifications, additions and substitutions are possible, without departing from the scope and spirit of the invention as disclosed in the accompanying claims. Also, the drawings are illustrative only to help understanding the invention. One should not think that the drawings are to limit the scope of claims.

Name of symbols

| | |
|---|---|
| 10: Light source | 20: DMD |
| 30: Projection lens | 40: Prism |
| 50: Asymmetric lens | 100: First lens |
| 200: Second lens (symmetric lens) | 300: DMD |
| 400: Prism | 500: Projection lens |

1. An optical system for a projection display apparatus including:
a first lens that transmits incident light from a light source with a same angle to a second lens;
a second lens that is positioned such that the light transmitted from the first lens enters a digital micromirror device (DMD) at a predetermined angle;
a DMD that reflects the incident light from the second lens;
a prism positioned between the second lens and the DMD that transmits and transfers the incident light from the second lens to the DMD, and transfers the reflected light from the DMD to a projection lens through total internal reflection;
a projection lens that projects the light onto a screen is positioned in the optical path of the reflected light that is total internally reflected from the prism.

2. The optical system for a projection display apparatus as claimed in claim 1, wherein the second lens is a symmetric lens that has a positive refractive power, and may be asymmetrically positioned with respect to an optical axis.

3. The optical system for a projection display apparatus as claimed in claim 2, wherein the second lens may be asymmetrically positioned such that it may be rotated at an angle within the range of 0° to 90° between a central axis of the second lens and a normal of an inclined side of the prism.

4. The optical system for a projection display apparatus as claimed in claim 2, wherein the second lens may be asymmetrically positioned such that it may be eccentrically positioned in a direction that the central axis of the second lens is away from the exit surface of the prism.

5. The optical system for a projection display apparatus as claimed in claim 3, wherein the second lens may be asymmetrically positioned such that it may be eccentrically positioned in a direction that the central axis of the second lens is away from the exit surface of the prism.
